(19) United States
(12) Patent Application Publication
(10) Pub. No.: US 2025/0256999 A1
(43) Pub. Date: Aug. 14, 2025

(54) SYSTEM AND METHOD FOR DEWATERING SOLIDS

(71) Applicant: Galileo Global Environmental Solutions, LLC, Dover, DE (US)

(72) Inventors: Avi Strulson, Closter, NY (US); Daniel J. Lynch, Victor, NY (US); Hannan Mike Barbanel, Manalapan, NJ (US); Arek Tarniowy, Manalapan, NJ (US)

(21) Appl. No.: 19/052,054

(22) Filed: Feb. 12, 2025

Related U.S. Application Data
(60) Provisional application No. 63/552,567, filed on Feb. 12, 2024.

(51) Int. Cl. C02F 11/128; A23K 10/38; B01D 29/31; B01D 29/90; B01D 35/157; B01D 37/00; C02F 103/32

(52) U.S. Cl. CPC C02F 11/128; A23K 10/38; B01D 29/31; B01D 29/906; B01D 35/1573; B01D 37/00; C02F 2103/32; C02F 2201/005; C02F 2303/26

(57) ABSTRACT

Embodiments included herein are directed towards a method and a system for dewatering solids. Embodiments of the present disclosure may include providing a funnel system including multiple funnel injection nozzles and at least one macerator. Embodiments may also include introducing a first material stream and a second material stream into the funnel system. Embodiments may also include combining the first material stream and the second material stream in the funnel system, resulting in a third material stream. Embodiments may also include transporting the third material stream to a filter container from the funnel system and separating solids from liquids contained in the third material stream in the filter container. Embodiments may also include removing the third material stream from the filter container by removing separated liquids from the filter container via a fourth material stream by using a hose system powered by a sludge pump.

### CROSS-REFERENCE TO RELATED APPLICATION(S)

The present application claims benefit of U.S. Provisional Patent Application No. 63/552,567, entitled “System and Methods for Dewatering Solids,” filed 12 Feb. 2024. The entire disclosure of which is incorporated herein by reference.

### TECHNICAL FIELD

The present disclosure generally applies to dewatering solids, more specifically a system and method for dewatering solids.

### BACKGROUND

In certain brewing processes, it is advantageous to recycle as much material as possible. One of the end products of a brewing process may be a material comprising a brewed solids material and an aqueous liquid material. Removing water or other liquid from this material may be advantageous, at least because the brewed material may be used as animal feed or in other ways, and because the water or other liquid may be reused in many different ways. Thus, a system that may remove water or other liquid from brewed solids material would have benefits.

### SUMMARY OF THE DISCLOSURE

As will be discussed in greater detail below, embodiments of the present disclosure include a dewatering solids system.

In one or more embodiments of the present disclosure, a method and a system associated with dewatering solids is included. The method may include providing a funnel system including multiple funnel injection nozzles and at least one macerator. The method may further include introducing a first material stream and a second material stream into the funnel system. The method may further include combining the first material stream and the second material stream in the funnel system, resulting in a third material stream. The method may further include transporting the third material stream to the filter container from the funnel system and separating solids from liquids contained in the third material stream in the filter container. The method may further include removing the third material stream from the filter container by removing separated liquids from the filter container via a fourth material stream by using a hose system powered by a sludge pump configured to transport the fourth material stream to different destinations. The method may further include removing separated solids from the filter container in a form of a dry cake material and recycling the separated solids for different purposes.

One or more of the following features may be included. In some embodiments, introducing the first material stream into the funnel system includes supplying the first material stream into the funnel system via the multiple funnel injection nozzles. In some embodiments, the holding tank is configured to supply the first material stream to the funnel system via the multiple funnel injection nozzles configured to move positions relative to the funnel system to facilitate combination of the first material stream and the second material stream. In some embodiments, the filter container includes an outlet valve at a bottom of the filter container to facilitate removal of the third stream material that passes through a filter to the bottom of the filter container. In some embodiments, the outlet valve is connected to the hose system to deliver the fourth material stream to the different destinations, the different destinations include at least one of a waste processing facility, a different storage location, and the holding tank. In some embodiments, the hose system is configured to transport multiple material streams leaving the filter container, each material stream with a different destination. In some embodiments, the funnel system is configured with different slope angles of a funnel to alter an amount of time that materials are inside the funnel. In some embodiments, a slope angle of the funnel is altered based on at least altering diameters of a top side or a bottom side of the funnel and a distance between the top side and the bottom side of the funnel. In some embodiments, the first material stream is an aqueous liquid stream and the second material stream comprises solid material entrained in a liquid. In some embodiments, the at least one macerator is configured to reduce a particle size of at least some solids entering and exiting the funnel system.

In one or more embodiments of the present disclosure, a system for dewatering solids is provided. The system may include a funnel system including multiple funnel injection nozzles and at least one macerator. The system further includes a holding tank including at least a tank inlet valve and a tank outlet valve. A pump is configured to transport a first material stream from the holding tank to the funnel system. The system further includes a chemical pump configured to feed materials to the holding tank. The system further includes a filter container powered by a sludge pump. The system further includes a hose system connected to the filter container. The system is configured to introduce the first material stream and a second material stream into the funnel system. The system is configured to combine the first material stream and the second material stream in the funnel system, resulting in a third material stream. The system is configured to transport the third material stream to the filter container from the funnel system and separate solids from liquids contained in the third material stream in the filter container. The system is configured to remove the third material stream from the filter container by removing separated liquids from the filter container via a fourth material stream by using the hose system powered by the sludge pump configured to transport the fourth material stream to different destinations. The system is configured to remove separated solids from the filter container in a form of a dry cake material and recycle the separated solids for different purposes.

One or more of the following features may be included. In some embodiments, introducing the first material stream into the funnel system includes supplying the first material stream into the funnel system via the multiple funnel injection nozzles. In some embodiments, the holding tank is configured to supply the first material stream to the funnel system via the multiple funnel injection nozzles configured to move positions relative to the funnel system to facilitate combination of the first material stream and the second material stream. In some embodiments, the filter container includes an outlet valve at a bottom of the filter container to facilitate removal of the third stream material that passes through a filter to the bottom of the filter container. In some embodiments, the outlet valve is connected to the hose system to deliver the fourth material stream to the different destinations, the different destinations include at least one of a waste processing facility, a different storage location, and the holding tank. In some embodiments, the hose system is configured to transport multiple material streams leaving the filter container, each material stream with a different destination. In some embodiments, the funnel system is configured with different slope angles of a funnel to alter an amount of time that materials are inside the funnel. In some embodiments, a slope angle of the funnel is altered based on at least altering diameters of a top side or a bottom side of the funnel and a distance between the top side and the bottom side of the funnel. In some embodiments, the first material stream is an aqueous liquid stream and the second material stream comprises solid material entrained in a liquid. In some embodiments, the at least one macerator is configured to reduce a particle size of at least some solids entering and exiting the funnel system.

The details of one or more example implementations are set forth in the accompanying drawings and the description below. Other possible example features and/or possible example advantages will become apparent from the description, the drawings, and the claims. Some implementations may not have those possible example features and/or possible example advantages, and such possible example features and/or possible example advantages may not necessarily be required of some implementations.

This summary is provided to introduce a selection of concepts that are further described below in the detailed description. This summary is not intended to identify essential features of the claimed subject matter, nor is it intended to be used as an aid in limiting the scope of the claimed subject matter.

### BRIEF DESCRIPTION OF THE DRAWINGS

The accompanying drawings, which are included to provide a further understanding of embodiments of the present disclosure and are incorporated in and constitute a part of this specification, illustrate embodiments of the present disclosure and together with the description serve to explain the principles of embodiments of the present disclosure.

FIG. 1 is an example diagrammatic view of a system for dewatering solids according to one or more example implementations of the disclosure;

FIG. 2 illustrates an example diagrammatic view of a holding tank in accordance with embodiments of the present disclosure;

FIGS. 3A-3J illustrate different diagrammatic views of a funnel system in accordance with embodiments of the present disclosure;

FIGS. 4A-4C illustrate different cross-sectional views of a staging system in accordance with embodiments of the present disclosure;

FIGS. 5A and 5B illustrate example diagrammatic views of a filter container in accordance with embodiments of the present disclosure;

FIG. 6 illustrates a cross section of an embodiment of the filter container as shown in FIG. 5B in accordance with embodiments of the present disclosure;

FIG. 7 illustrates a cross-sectional view of the filter container after an occurrence of a separation of liquids and solids in accordance with embodiments of the present disclosure;

FIGS. 8A-8F illustrate different stages and connections of the system for dewatering solids in accordance with embodiments of the present disclosure;

FIG. 9 illustrates a flowchart in accordance with embodiments of the present disclosure; Like reference symbols in the various drawings may indicate like elements.

### DETAILED DESCRIPTION

The discussion below is directed to certain implementations. It is to be understood that the discussion below is only for the purpose of enabling a person with ordinary skill in the art to make and use any subject matter defined now or later by the patent “claims” found in any issued patent herein.

It is specifically intended that the claimed combinations of features not be limited to the implementations and illustrations contained herein, but include modified forms of those implementations including portions of the implementations and combinations of elements of different implementations as come within the scope of the following claims. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure. Nothing in this application is considered critical or essential to the claimed invention unless explicitly indicated as being “critical” or “essential.”

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the invention. The first object or step, and the second object or step, are both objects or steps, respectively, but they are not to be considered a same object or step.

In certain brewing processes, it is advantageous to recycle as much material as possible. One of the end products of a brewing process may be a material comprising a brewed solids material and an aqueous liquid material. Removing water or other liquid from this material may be advantageous, at least because the brewed material may be used as animal feed or in other ways, and because the water or other liquid may be reused in many different ways. Traditionally, the system for the brewing process discharges a liquid waste from a centrifuge into metal totes and discharges solid waste into plastic totes, requiring manual handling. This process is not only inefficient and messy, but also unsustainable. Thus, a system that may automate the entire waste collection and separation process of removing water or other liquid from brewed solids material and eliminating the need for human operation would have benefits and would make the system more planet-friendly.

The present invention is directed to a method and a system associated with dewatering solids. A dewatering system, operated as described in the illustrative embodiments herein, allows for a beneficial use of many of the solids and liquids that are processed by the system. The dewatering system with a funnel system may be used to receive various incoming liquid streams via a holding tank. A first material stream supplied by the holding tank and a second material stream may be facilitated to combine in the funnel system to ultimately create a third material stream. The third material stream may be transported to a filter container for separating liquids from solids in the third material stream in the filter container and removing separated liquids from the filter container. For example, the dewatering system may redirect a waste stream upwards into a waste water tank (e.g., waste water tank 195A) or a frac tank (e.g., frac tank 195B), hundreds of feet away from a processing area. This change allows for a movement of large waste quantities without operator intervention. Often times material streams left after separating liquids from solids in the third material stream like those described herein are waste streams, have no productive use, and are costly to dispose of. The dewatering system allows for reuse of the solid materials involved (for example, as animal feed) and the recycling of liquid materials involved (for example, by reintroducing the liquid materials as the first material stream), and thus creates economically beneficial uses out of materials that otherwise would have no economic use.

One or more embodiments of the present invention provides solution of utilizing a layer of liquid that has passed through filter system and accumulated at a bottom of the filter container during and after separation as a separated liquid. This separated liquid is removed from the filter container. The liquid may be moved to many different areas, for example to a waste facility, a fractal tank, or to holding tank so that it may be reintroduced to the system. A separated solids layer also forms in the filter container during or after separation. In some embodiments, the separated solids form a dry cake material and may be removed from the filter container and used in many different ways, for example as animal feed, compost, waste material, fuel, or for other uses.

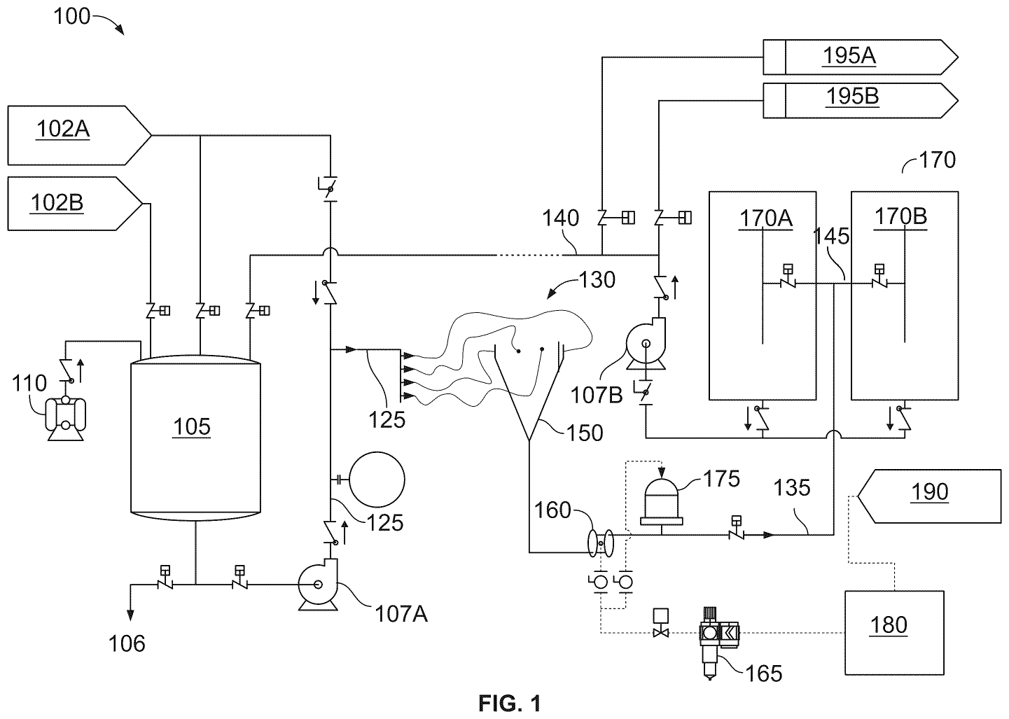

FIG. 1 illustrates a system 100 for dewatering solids in accordance with embodiments of the present disclosure. System 100 as described herein is one possible embodiment, elements of which may be varied or modified from those described and still remain within the scope of the disclosure.

System 100 includes a holding tank 105 connected with a drain 106. Holding tank 105 stores fluids that are used in various portions of system 100. Holding tank 105 is configured to receive various incoming liquid streams, for example, from a city water 102A and a reverse osmosis (RO) reject water 102B as shown in FIG. 1. Optionally, system 100 includes multiple holding tanks 105 coupled to a common output to feed downstream equipment in system 100.

Holding tank 105 supplies a first material stream 125 to a conical funnel system 150. First material stream 125 may comprise a variety of materials. In one embodiment, first material stream 125 is an aqueous liquid stream. First material stream 125 is introduced into conical funnel system 150. A second material stream 130 is also introduced into conical funnel system 150. Second material stream 130 comprises solid material entrained in a liquid, and may comprise a variety of materials. In one embodiment, second material stream 130 is a stream of spent tea leaves, the stream comprising tea leaves and an aqueous liquid. Flow rates and pressure levels for the material streams, particularly first material stream 125 (aqueous liquid) is approximately 26-30 gallons per minute (GPM) and second material stream (solids in liquid) may have 20 pounds of bi-product (e.g., spent tea leaves, spent Coffee grain, spent barley, or spent hops). Composition of incoming material streams (e.g., percentage of water vs. solids) may be approximately 60% liquid to 40% bi-product.

First material stream 125 and second material stream 130 are combined in conical funnel system 150. After combination, first material stream 125 and second material stream 130 form a third material stream 135. Third material stream 135 is then removed from conical funnel system 150 via a hose or pipe 145 and is moved towards filter container 170 (e.g., filter containers 170A and 170B) with an ultrasonic level transmitter, powered by a 3″ sludge pump 160. Sludge pump 160 may further connect to an air regulator 165 with approximately 80 pounds per square inch (PSI), a tranquilizer 175, an air receiver tank 185 and a compressor air 190 as shown in FIG. 1.

Third material stream 135 flows into filter container 170. Third material stream 135 may comprise many different materials. In one embodiment, third material stream 135 contains water and spent tea leaves.

Filter container 170 is configured to separate the liquids from the solids in the third material stream 135. After separation, the separated liquid may be removed from filter container 170, via fourth material stream 140. The fourth material stream may be transported to different locations, for example in some embodiments it may be transported to holding tank 105, and in other embodiments it may be transported to a waste processing location. For example, the fourth material stream may be redirected as a waste stream upwards into a waste water tank (e.g., waste water tank 195A) or a frac tank (e.g., frac tank 195B), hundreds of feet away from a processing area via a pump 170B. Pump 170B may have an approximately 40 PSI with a configuration of 2 HP motor with three phase 460 V.

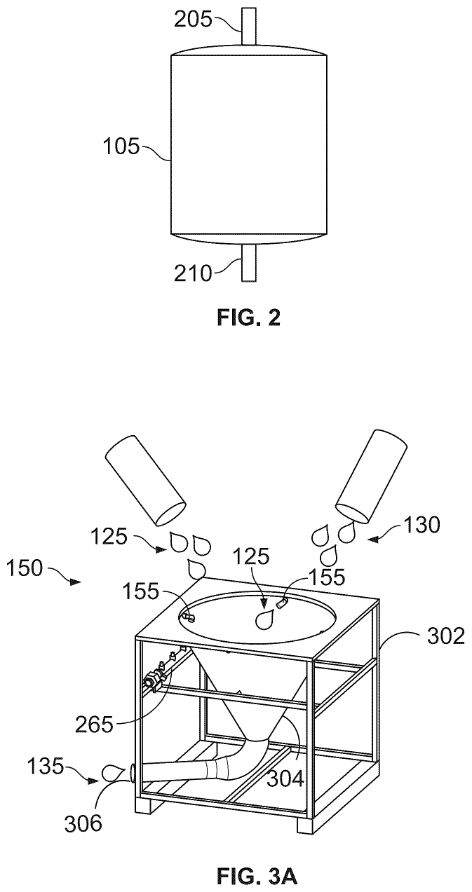

FIG. 2 illustrates a holding tank 105 in accordance with embodiments of the present disclosure. Holding tank 105 as described herein illustrates one possible embodiment, elements of which may be varied or modified from those described and still remain within the scope of the disclosure.

Holding tank 105 with an approximate capacity of 1000 gallons has at least a tank inlet valve 205 and a tank outlet valve 210. An inlet valve 205 is used to facilitate introduction of material into the holding tank 105, and an outlet valve 210 is used to facilitate removal of material from holding tank 105. In other embodiments, holding tank 105 has multiple inlet valves 205 and multiple outlet valves 210. Inlet valves and outlet valves may be configured to remove gases, liquids, solids, or a combination of one or more of gases, liquids, or solids from holding tank 105 via multiple pumps and sensors.

Holding tank 105 may be configured to include different total numbers of inlet valves 125 and outlet valves 130. For example, the holding tank 105 may have only one inlet valve 125 and one outlet valve 130. Alternatively, there may be only one valve that serves as an inlet valve 125 and an outlet valve 130. Further, there may be a multiplicity of inlet valves and outlet valves along with pumps, and sensors involved in the operations of holding tank 105. The number of inlet valves does not need to equal or correspond to the number of outlet valves. In some embodiments, control mechanisms of holding tank 105 may include automated valve sequencing and/or monitoring systems for regulating liquid levels in holding tank 105.

System 100 may be configured so that many different material streams enter the holding tank 105. For example, incoming liquid streams may include rejected water from city water 102A, an adjacent process (e.g., RO reject water 102B), and recycled aqueous liquid from different stages in system 100. In some embodiments, the liquid in the incoming liquid streams comprises tea or a different brewed liquid. In some embodiments the incoming material stream or streams include solid materials.

In some embodiments, there is a chemical pump 110 that feeds materials to holding tank 105. For example, chemical pump 110 may be configured to sanitize or clean holding tank 105. Chemical pump 110 may charge holding tank 105 with cleaner, the cleaner may be combined with water, and the resulting mixture may be circulated through all of, or portions of, system 100 in order to clean all or some portions of system 100. In some embodiments, chemical pump 110 may charge system 100 with small levels of cleaner in a continuous manner, to facilitate operation of system 100 by ensuring a lack of debris buildup and/or microorganism growth.

In some embodiments, a pump 107A with an approximately 45 PSI is configured to transport a first material stream 125 from holding tank 105 to conical funnel system 150. For example, pump 107A may have a configuration of 1 HP motor with three phase 460 V.

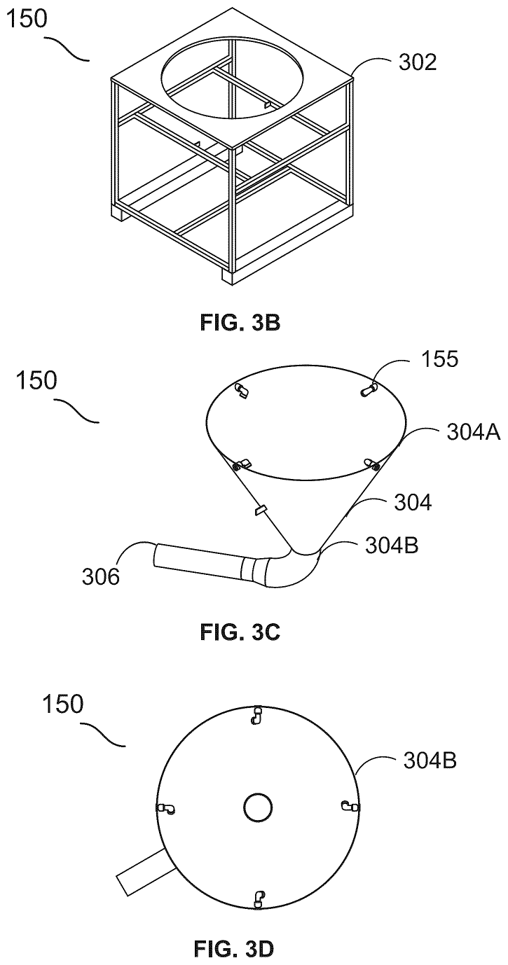

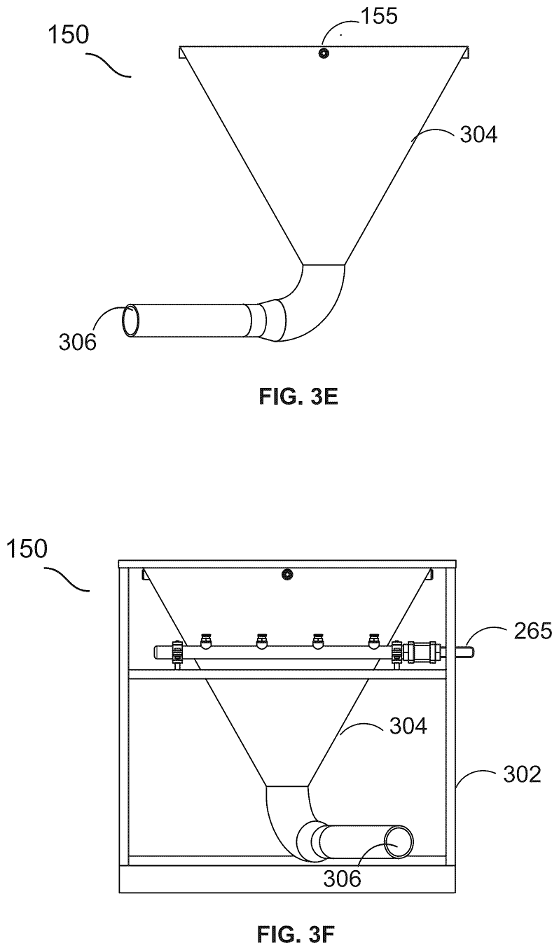

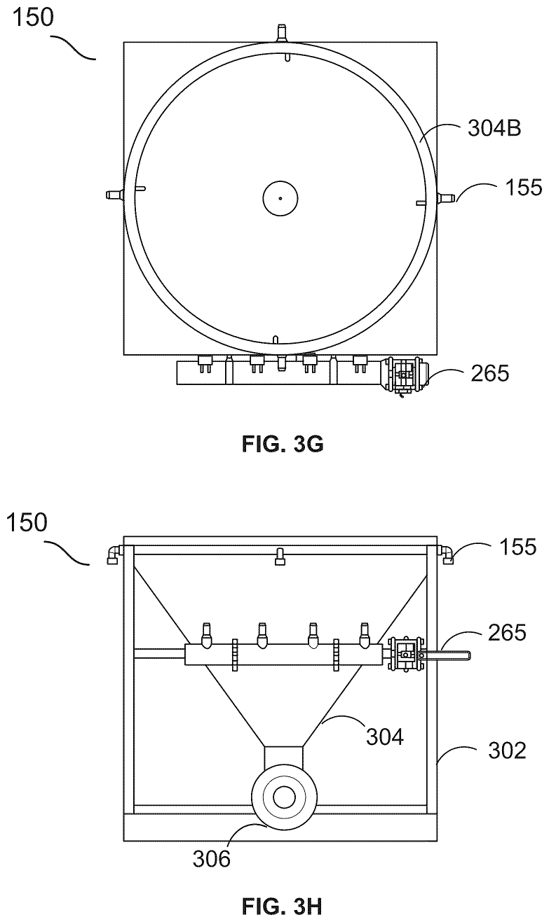

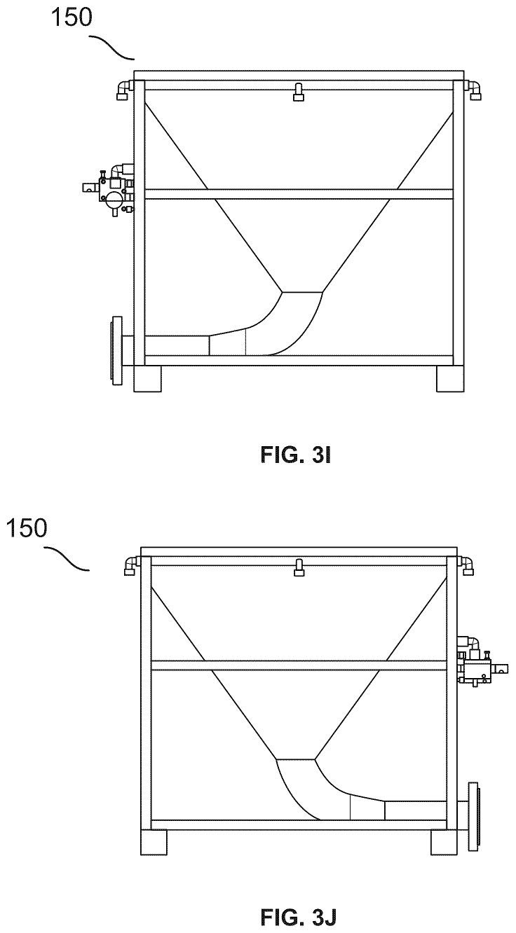

FIGS. 3A-3J illustrate different diagrammatic views of a funnel system in accordance with embodiments of the present disclosure. FIG. 3A illustrates a funnel system 150 in accordance with embodiments of the present disclosure. The funnel system, for example, conical funnel system 150 as described herein illustrates one possible embodiment, elements of which may be varied or modified from those described and still remain within the scope of the disclosure. Conical funnel system 150 may include a frame 302 (shown in FIG. 3B) supporting a funnel 304 (shown in FIGS. 3C-3E). Conical funnel system 150 is used to facilitate the combination of first material stream 125 and second material stream 130. Frame 302 may be constructed from a stainless steel industrial-grade polymer to provide durability, chemical resistance, and ease of cleaning. In some embodiments, material composition for frame 302 may include stainless steel, corrosion-resistant alloys, or reinforced polymer composites. Load bearing capacity of frame 302 may ensure that frame 302 withstands vibrations and flow forces from various injected streams. In some embodiments, frame 302 may include mounting and adjustability features for shock-absorbing mounts.

In the illustrative embodiment, first material stream 125 is introduced into conical funnel system 150 partly via funnel injection nozzles 155. In some embodiments, first material stream 125 is introduced only via funnel injection nozzles 155. Funnel injection nozzles 155 may be distributed around the upper portion 304A of conical funnel system 150. As first material stream 125 is transported from holding tank 105 to the conical funnel system, the material stream flows through a larger diameter hose, and then the stream is separated into four smaller diameter hoses before being introduced into conical funnel system 150. The four smaller diameter hoses terminate in funnel injection nozzles 155, which are distributed roughly evenly around the upper portion 304A of the conical funnel. The four smaller diameter hoses are held in place by staging system 265.

In some embodiments, funnel injection nozzle or nozzles 155 may be configured in different ways as shown in FIGS. 3C-3G. For example, any number of funnel injection nozzles 155 may be used depending on the objective. Funnel injection nozzles 155 may be configured to rotate or otherwise move positions relative to conical funnel system 150, as this movement may facilitate combination of first material stream 125 and second material stream 130. Funnel injection nozzles 155 may be located in different positions in conical funnel system 150, including different positioned along the height of the funnel system. In some embodiments, funnel injection nozzles 155 are angled at least one degree away from straight down the funnel, and in other embodiments funnel injection nozzles 155 are angled multiple degrees away from straight down. For example, the nozzles may be angled at any position away from straight down, including 5, 10, 15, 20, 25, 30, 35, 40, 45, 50, 55, 60, 65, 70, 75, 80, or 85 degrees away from straight down, relative to the horizontal.

Different trajectories of first material stream 125, as introduced by injection nozzles 155, may facilitate more efficient combination of first material stream 125 and second material stream 130. In some embodiments, the partially sideways trajectory of first material stream 125 helps to create a vortex-like flow of the material stream inside conical funnel system 150, which helps more effectively mix the material streams in the funnel.

In some embodiments, funnel injection nozzles 155 are spaced evenly along a cross-sectional perimeter of the conical funnel system. In some embodiments, funnel injection nozzles 155 are spaced along an inner cross-sectional circumference of the conical funnel system. The nozzles may be spaced differently according to different desired flow profiles of first material stream 125. The additional nozzles may be added to separate the circulatory recycling of the waste in the conical funnel system, as shown in FIGS. 3C and 3D, which provide a key factor in water conservation, from the RO water, ensuring it may not be cross-contaminated by the solids (e.g., dispensed tea leaves). Additionally, one nozzle may be added at the very bottom to provide an extra flush for “stubborn” solids, preventing accumulation and ensuring the solids enter the flow properly. Funnel 304 of the funnel system is described illustratively herein as a conical shape, however funnel 304 may resemble other shapes including a prism, cylinder, rhomboid, or the like, depending on requirements of system 100. FIGS. 3F-3J illustrate different views of conical funnel system 150 indicating funnel system enhancements in accordance with embodiments of the present disclosure. In particular, FIGS. 3F-3J show how injection angles for funnel injection nozzles 155 may create vortex flow and further indicate an adjustable nozzle positioning to fine-tune the mixing dynamics of the material streams in the funnel.

In some embodiments, third material stream 135 is then removed from conical funnel system 150 via hose or pipe 145 (shown in FIG. 1) connected to a 3″ flange 306 at an end of the funnel 304 as shown in FIG. 3A and is moved towards filter container 170 (shown in FIG. 1), powered by sludge pump 160 (shown in FIG. 1).

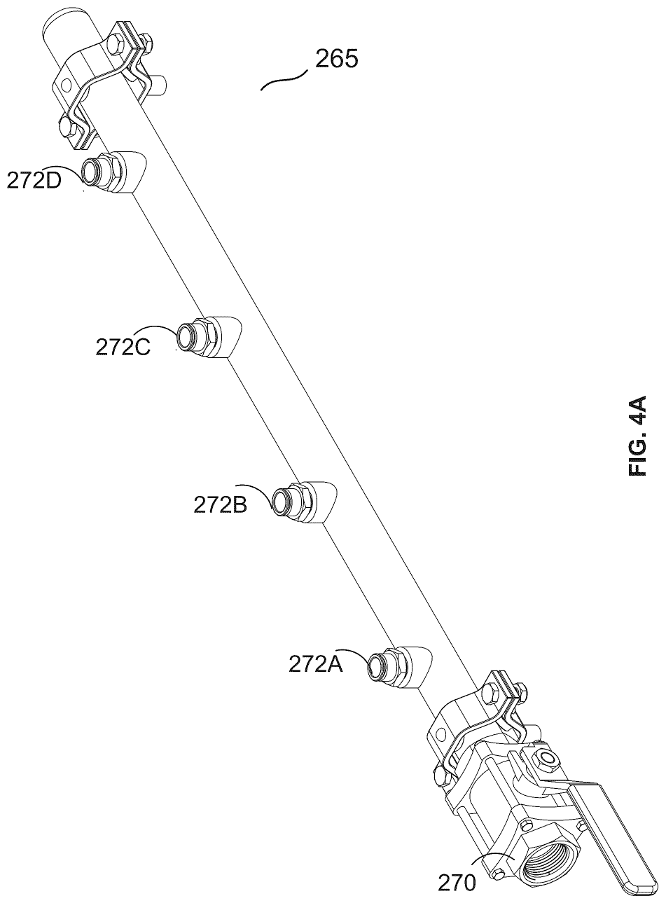

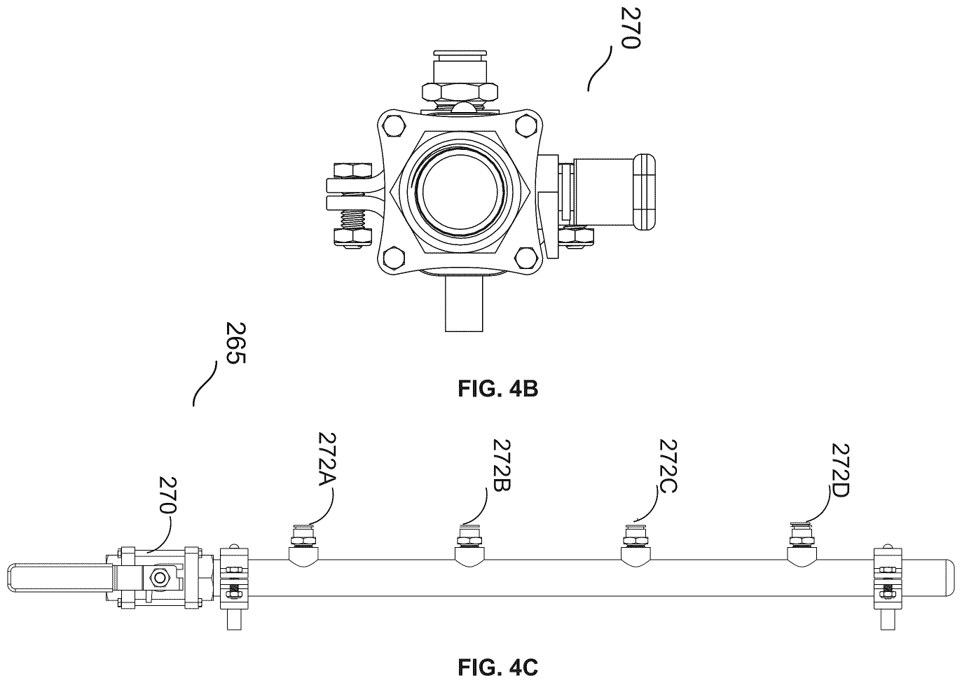

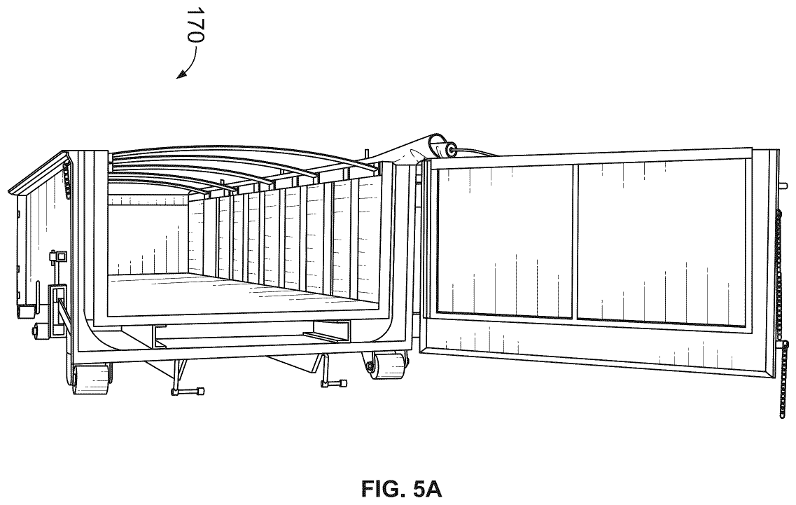

In some embodiments, conical funnel system 150 includes a staging system 265 as shown in FIGS. 3F-3H. Staging system 265 may help organize the transport lines that terminates in funnel injection nozzles 155. For example, staging system 265 may be coupled to a side of conical funnel system 150 at a fixed end 270 (as shown in FIG. 4B). As first material stream 125 is transported to conical funnel system 150, the material first flows through a high-volume transport line and the high-volume transport line transitions to multiple lower volume transport lines, each of which terminate in a funnel injection nozzle 155, and each of which is secured in place with the help of staging system 265.

FIGS. 4A-4C illustrate different views of staging system 265 in accordance with embodiments of the present disclosure. In some embodiments, staging system 265 may have multiple channels (e.g., channels 272A, 272B, 272C, 272D) to secure the lower volume transport lines in an orderly fashion, thus staging system 265 may organize hoses and transport lines. The function of fixed end 270 is to stabilize and align the injection system, ensuring proper flow into funnel 304.

Second material stream 130 is introduced into conical funnel system 150. In certain embodiments there is a conveyor system that brings second material stream 130 into conical funnel system 150. Depending on the content of second material stream 130 and other process variables, many different mechanisms may be used to introduce second material stream 130 into conical funnel system 150.

In some embodiments, second material stream 130 comprises solids and liquids. As an example, second material stream 130 may comprise spent tea leaves from an adjacent process, the spent tea leaves including tea leaves and an aqueous liquid. A certain ratio of liquids to solids may be targeted in second material stream 130. For example, second material stream 130 may have a target ratio of 70% liquids to 30% solids by volume, 80% liquids to 20% solids by volume, or 90% liquids to 10% solids by volume in some embodiments.

In some embodiments, conical funnel system 150 may be configured to facilitate the combination of first material stream 125 and second material stream 130, to ultimately create a third material stream 135. The material streams may be combined to create third material stream 135 with different characteristics, depending on process requirements. For example, it may be desired for third material stream 135 to have a target viscosity, density, solids count, solid to liquid ratio, or the like. In some embodiments, the third material stream has a target ratio of 70% liquids to 30% solids by volume, 80% liquids to 20% solids by volume, or 90% liquids to 10% solids by volume. Adjusting the flow rate, solids content, or other parameters of one or both of first material stream 125 and second material stream 130 facilitates the achievement of the targeted characteristics in third material stream 135.

In some embodiments, conical funnel system 150 may be configured with a certain slope angle. Generally, a higher slope angle may cause the materials introduced into conical funnel system 150 to move quickly to bottom of the funnel 304B. Similarly, a lower slope angle may cause the materials to reach bottom of the funnel 304B more slowly. Thus, configuring the conical funnel system 150 with different slope angles may alter the amount of time that materials are in the funnel. In some embodiments, different slope angles help to reduce the amount of time that materials are in the funnel.

In the illustrative embodiment, conical funnel system 150 is shaped generally like a cone, and two opposite sides of the cone-like funnel are open. One of these sides, the top side, has a larger diameter than the other side. To alter the slope angle of the funnel, the diameters of top side 304A or bottom side 304B may be increased or decreased. Further, altering the height of the funnel (the distance between top side 304A and the bottom side 304B) may also alter the slope angle of the funnel. In the illustrative embodiment, conical funnel system 150 is generally cone-shaped, however, differently shaped funnel systems may be used provided the funnel systems are configured to facilitate combination of different material streams.

In some embodiments, the length of the top side, the length of the bottom side, and the height of the funnel create a slope angle of at least a certain degree, for example a slope angle of at least 5, 10, 15, 20, 25, 30, 35, 40, 45, 50, 55, 60, 65, 70, 75, 80, or 85 degrees relative to the horizontal.

In certain embodiments, conical funnel system 150 comprises at least one macerator. The macerator is configured to reduce the particle size of at least some solids entering conical funnel system 150, or to reduce the particle size of at least some solids exiting conical funnel system 150. The macerator may be placed in different locations, for example above the conical funnel system, between top side 304A (as shown in FIG. 3C) and bottom side 304B (as shown in FIG. 3D) of conical funnel system 150, or below bottom side 304B of conical funnel system 150. In other embodiments, there are multiple macerators.

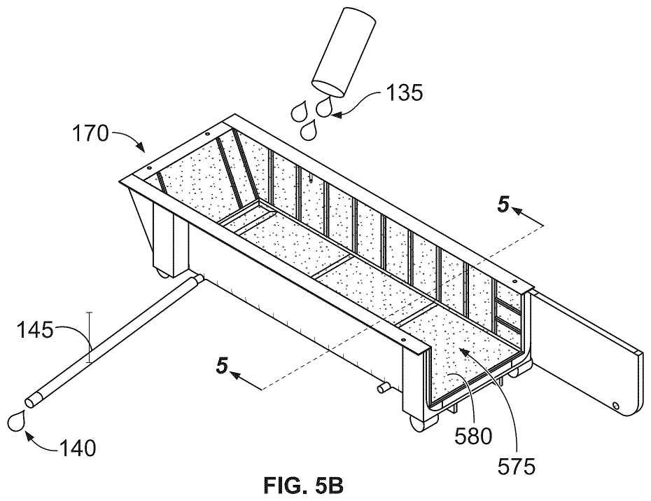

FIGS. 5A and 5B illustrate a filter container 170 in accordance with embodiments of the present disclosure. Filter container 170 as described herein illustrates one possible embodiment, elements of which may be varied or modified from those described and still remain within the scope of the disclosure. Filter container 170 is used to facilitate the separation of solids from liquids contained in third material stream 135, and to facilitate the removal of the resulting materials after separation.

Third material stream 135 is transported to filter container 170 from conical funnel system 150. A system including a hose and a sludge pump 160 is configured to transport third material stream 135 from conical funnel system 150 to filter container 170 as shown in FIG. 5B. A pipe or the like may also be used to move third material stream 135.

In some embodiments, sludge pump 160 may be operated with the use of electricity, compressed air 190 (shown in FIG. 1), a hydraulic system, or the like. The mass of the liquid in the material stream to the total mass of the material stream is at least a ratio, for example the ratio of the liquid mass to the total material stream mass is at least a ratio of 0.01, 0.02, 0.03. 0.04, 0.05, 0.1, 0.15, 0.2, 0.25, 0.3, 0.4, 0.5, 0.6, 0.7, 0.8, 0.9, or 1.

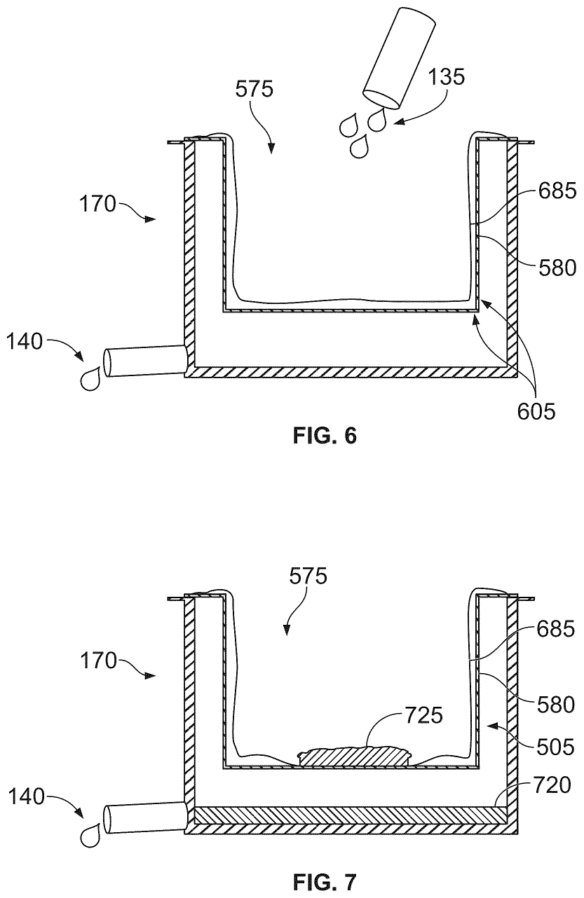

Filter container 170 contains a filter system 575. Filter system 575 may comprise different filters based on the desired operation of overall system 100. In some embodiments, filter system 575 comprises a fabric filter 685 (see discussion of FIG. 6, below). For example, fabric filter 685 may be a micron filter, including a 130 micron filter. Filter system 575 may also comprise a metal filter 580. In some embodiments, fabric liner 685 may have 130 micron porosity and metal filter 580 (“metal cage frame/filter”) may have 0.5 inch hole mesh size. In some embodiments, filter container 170 is a storage container, and filter system 575 lines the entire filter container 170. In some embodiments, filter system 575 covers the entire filter container 170.

In some embodiments, filter system 575 is suspended inside filter container 170. The material that passes through filter system 575 may collect at the bottom of filter container 170. Collection of material below filter system 575 is advantageous for removal of the material that passes through filter system 575. Suspending filter system 575 may be advantageous as suspension enables material that does not pass through filter or filters 580 to be more quickly dried due to the open space immediately above and/or below filter or filters 580.

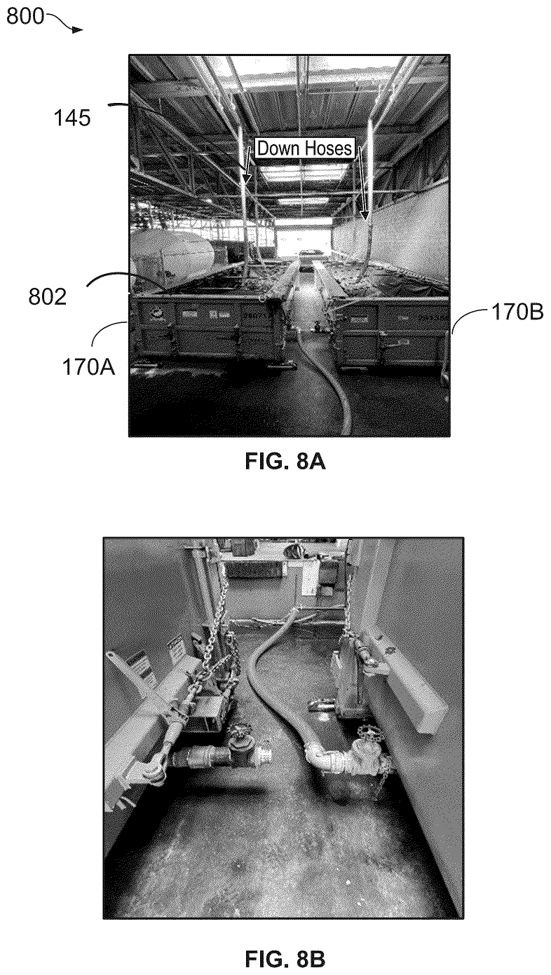

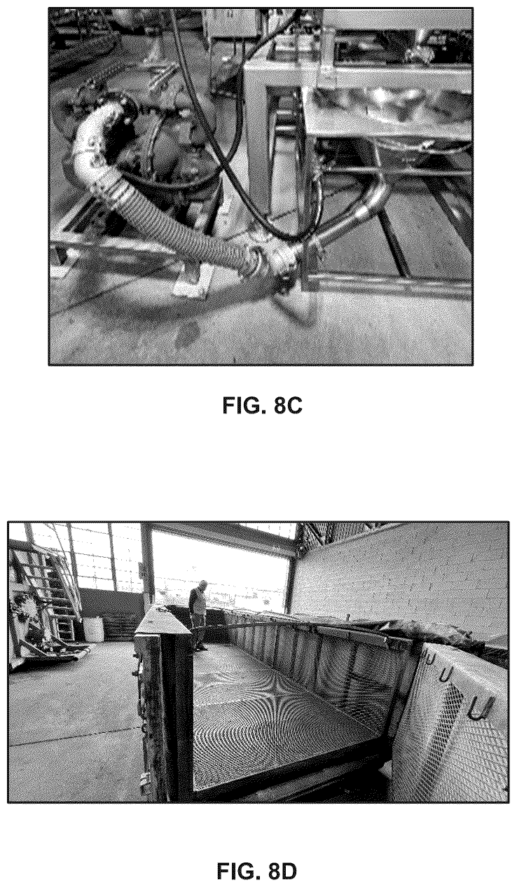

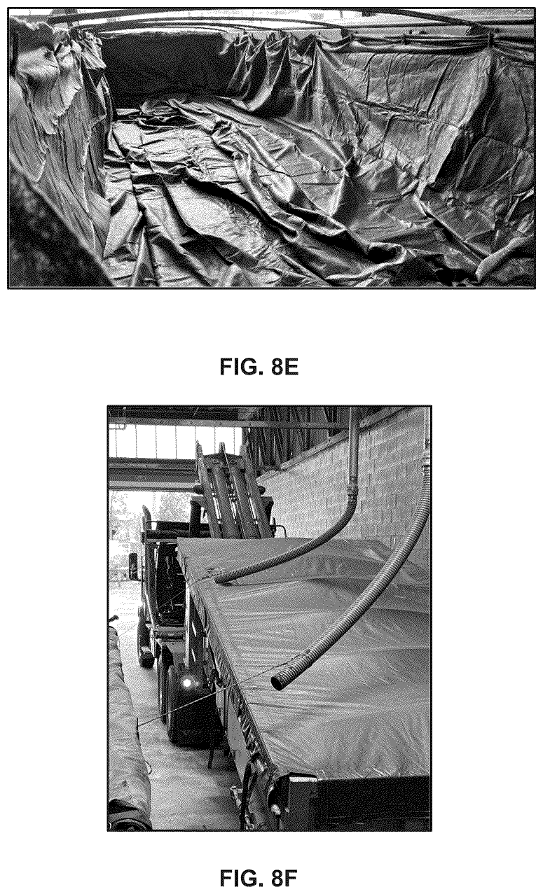

In certain embodiment, a fourth material stream 140 is removed from filter container 170. Filter container 170 includes an outlet valve at the bottom of the container to facilitate removal of the material that passes through the filter to the bottom of the filter container. The outlet valve may be connected to, for example, a hose or pipe system that includes a pump, where the pump is configured to transport fourth material stream 140. The hose system may be configured to deliver fourth material stream 140 to different locations, for example, a waste processing facility, a different storage location, or to holding tank 105. In further embodiments, there may be multiple material streams leaving filter container 170, each with a different destination. In some embodiments, the hose system usually includes a 3″ drain hose connected to filter container 170 as shown in FIG. 8B.

In some embodiments, filter container 170 is configured so that the entire container 170 may be removed from system 100. For example, filter container 170 may be a roll off dumpster which is loaded onto a roll off truck, as shown in FIGS. 8D-8F. The roll off truck may bring the unused filter container 170 to the dewatering site, and remove filter container 170 from the dewatering site after dewatering has occurred, which may also have the advantage of allowing any residual solids material to be easily transported.

FIG. 6 depicts a cross section of an embodiment of filter container 170 as shown in FIG. 5B in accordance with embodiments of the present disclosure. The cross section is taken along line 5-5 shown in FIG. 5B. Fabric filter 685 has been added into the cross-sectional view, to illustrate another embodiment.

As shown in the illustrative embodiment in FIG. 6, filter system 575 is suspended in filter container 170. Suspending filter system 575 creates head space 605 below the filter system and on both sides of the filter system. Head space 605 facilitates the separation process since it allows liquid to collect below the filter system. Without sufficient head space 605, the liquid would collect at the bottom of the container and reach the filter system, thus blocking the flow of further liquid through the filter. Thus, without sufficient head space, sufficient separation of liquids from solids may not be possible until liquid is removed from the bottom of filter container 170. Sufficient head space 605 impacts on separation efficiency by allowing sufficient separation of liquids from solids without removing the liquids, or the solids, from filter container 170, thus allowing more flexibility in the use of filter container 170. For example, head space 605 may provide 6″ of head space between the metal mesh cage (e.g., metal filter 580) in a bin of filter container 170 to an inside wall of the bin. In embodiments where head space 605 is included to the sides of filter system 575, separation of liquids from solids may occur more quickly than if head space is only included below the filter system, given that the liquid may pass through the filter system on either side of the system, as well as below the system.

The examples of filter system 575, metal filter 580, and fabric filter 685 are illustrative. Filter system 575 may be configured with many different types of filters. For example, filter system may only include metal filter 580 or fabric filter 685, may comprise more than one fabric filter or more than one metal filter, and each filter may be sized differently according to different process goals. In some embodiments, metal filter 580 is welded or otherwise secured to filter container 170 and provides a support structure for overlaying fabric filter 685.

FIG. 7 depicts a cross-sectional view of filter container 170 after a separation of liquids and solids has occurred in accordance with embodiments of the present disclosure. During and after separation, a layer of liquid that has passed through filter system 575 accumulates at the bottom of filter container 170 as separated liquid 720. This separated liquid 720 is removed from the filter container as fourth material stream 140. The liquid may be moved to many different areas, for example to a waste facility, a fractal tank, or to holding tank 105 so that it may be reintroduced to system 100. A separated solids layer 725 also forms in filter container 170 during or after separation. In some embodiments, separated solids 725 form a dry cake material. Separated solids 725 may be removed from filter container 170 and used in many different ways, for example as animal feed, compost, waste material, fuel, or for other uses. Although separated solids layer 725 is shown as filling only a portion of the inner space of filter system 575, separated solids layer 725 may fill the entire inner space of filter system 575. Drain rate from filter container 170 varies between 25-50 GPM depending on level of liquid in filter container 170. Drain rate sludge (bi-product) varies depending on the nature of exact bi-product, for example, spent tea leaves may dry 90-95% in 6-8 hours.

FIGS. 8A-8F depict different stages and connections of the system for dewatering solids in accordance with embodiments of the present disclosure. FIG. 8A shows an exemplary dewatering system during preliminary checks in accordance with embodiments of the present disclosure. For example, during preliminary checks, the filter containers may be verified to be under down pipes/hoses (e.g., hose or pipe 145) (LEFT) or (RIGHT) and a disposable liner in the filter containers (tarp should be rolled up and on sides visible) may be verified as well. In addition, the down pipes/hoses (e.g., hose or pipe 145) may be verified to be in the filter container and unobstructed.

FIG. 8B shows an exemplary filter container connected with a 3″ drain hose is in accordance with embodiments of the present disclosure. In some embodiments, it is made sure that a drain valve is open so the filter container may drain (clockwise=closed; counterclockwise=open). A dock air pump may be switched ON with a recommended pressure of 15 PSI and it may be made sure that the pressure level should not exceed 30 PSI. In some embodiments, for the filter container to be filled, the valves may be opened at a control panel. Each valve may take 10 to 15 seconds to open or close. When lights of the control panel are ON, it indicates the valve is open.

FIG. 8C shows an exemplary batching process during or after separation in accordance with embodiments of the present disclosure. In some embodiments, during batching an operator needs to stay by the batch and cylinder until the batch is completed. After batching, the air may be turned OFF and the water may keep running to fill the cylinder (two to three times or until clear water is seen coming through the downpipes). Once the cylinder is filled, the air is turned ON to flush lines and valves. After flushing, the water may be turned OFF and after waiting for 10 seconds, the air may be turned OFF. After the process, all valves may be kept open while ensuring the filter containers are with liner below the pipes. The water may run through wither pump for at least two to four cycles of filling the cylinder with water to flush all the lines and valves. At the end, dock pump may be turned off.

FIG. 8D shows an exemplary filter container in accordance with embodiments of the present disclosure. The filter container as showed herein illustrates one possible embodiment, elements of which may be varied or modified from those described and still remain within the scope of the disclosure. The filter container (e.g., filter containers 170A and 170B) showed in FIG. 8D is configured to facilitate the separation of solids from liquids contained in third material stream 135, and to facilitate the removal of the resulting materials after separation as described above. FIG. 8E shows the filter container 800 (e.g., filter containers 170A and 170B) with a new disposable liner 802 in accordance with embodiments of the present disclosure. For example, for best practices, new disposable liner 802 is installed on receiving a new container to facilitate the removal of the resulting materials after separation. FIG. 8F shows an exemplary filter container (e.g., filter container 170A) filled with the resulting materials after separation in accordance with embodiments of the present disclosure. For example, a dock pump is kept ON for a minimal of 10 minutes to remove any remaining water from the filter container. The down pipes/hoses (e.g., hose or pipe 145) are repositioned and tied away from the filter container. It is then verified either automatically or by the operator that the filter container is ready for hauling and may disconnect the drain hose and may transfer the drain hose to the other filter container (e.g., filter container 170B) (if not already done). Finally, the full filter container is removed.

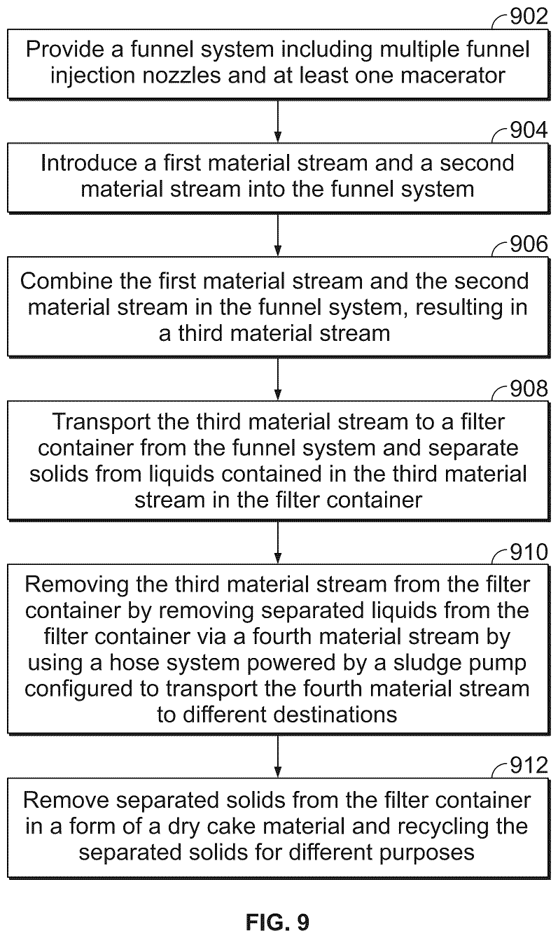

FIG. 9 depicting a method of dewatering solids in accordance with embodiments of the present disclosure is shown. In step 902, a funnel system comprising multiple funnel injection nozzles and at least one macerator is provided. For example, the funnel system (e.g., conical funnel system 150) detailed in the illustrative embodiments above may be provided in order to facilitate the mixing of different material streams. Multiple funnel injection nozzles (e.g., funnel injection nozzles 155) may be configured to rotate or otherwise move positions relative to conical funnel system 150. Funnel injection nozzles 155 may be located in different positions in conical funnel system 150, including different positioned along the height of the funnel system. In some embodiments, funnel injection nozzles 155 are angled at least one degree away from straight down the funnel, and in other embodiments funnel injection nozzles 155 are angled multiple degrees away from straight down. For example, the nozzles may be angled at any position away from straight down, including 5, 10, 15, 20, 25, 30, 35, 40, 45, 50, 55, 60, 65, 70, 75, 80, or 85 degrees away from straight down, relative to the horizontal. In some embodiments, funnel injection nozzles 155 are spaced evenly along a cross-sectional perimeter of the conical funnel system. In some embodiments, funnel injection nozzles 155 are spaced along an inner cross-sectional circumference of the conical funnel system.

In some embodiments, the macerator (not shown) is configured to reduce the particle size of at least some solids entering conical funnel system 150, or to reduce the particle size of at least some solids exiting conical funnel system 150. The macerator may be placed in different locations, for example above the conical funnel system, between the top side and the bottom side of conical funnel system 150, or below the bottom side of conical funnel system 150. In other embodiments, there are multiple macerators.

In step 904, a first material stream and a second material stream are introduced into the funnel system. For example, holding tank 105 is configured to receive various incoming liquid streams. Optionally, system 100 includes multiple holding tanks 105 coupled to a common output to feed downstream equipment in system 100. In some embodiments, holding tank 105 supplies a first material stream 125 to a conical funnel system 150. First material stream 125 may comprise a variety of materials. In one embodiment, first material stream 125 is an aqueous liquid stream. First material stream 125 is introduced into conical funnel system 150. A second material stream 130 is also introduced into conical funnel system 150. Second material stream 130 comprises solid material entrained in a liquid, and may comprise a variety of materials. In one embodiment, second material stream 130 is a stream of spent tea leaves, the stream comprising tea leaves and an aqueous liquid.

In step 906, a first material stream and a second material stream are combined in the funnel system, resulting in a third material stream. For example, conical funnel system 150 may help combine material streams such as first material stream 125 and second material stream 130 detailed above. After combination, first material stream 125 and second material stream 130 form a third material stream 135. The third material stream may be similar to third material stream 135 described above. The combination of first and second material streams inside the funnel may occur with the aid of elements described above, for example with the aid of funnel injector nozzles and the staging system.

In step 908, the third material stream is transported to a filter container from the funnel system and solids from liquids contained in the third material stream are separated in the filter container. The filter container and its components may be similar or the same as the filter container and related elements described throughout this disclosure. For example, third material stream 135 flows into filter container 170. Third material stream 135 may comprise many different materials. In one embodiment, third material stream 135 contains water and spent tea leaves. Filter container 170 is configured to separate the liquids from the solids in the third material stream 135.

In step 910, the third material stream from the filter container is removed by removing separated liquids from the filter container via a fourth material stream by using a hose system powered by a sludge pump configured to transport the fourth material stream to different destinations, as depicted in FIGS. 8A-8F. For example, the liquids and solids in the third material stream are separated from each other inside the filter container. Liquids may be removed, for example, in a stream like fourth material stream described in this disclosure. For example, after separation, the separated liquid may be removed from filter container 170, via fourth material stream 140. The liquids may be removed in various ways, for example the liquid may be hauled away, moved to a fractal tank, or introduced into holding tank 105 and ultimately reintroduced throughout system 100.

In step 912, separated solids from the filter container are removed in a form of a dry cake material and the separated solids are recycled for different purposes. In some embodiments, there is a residual “dry cake” left after separation, which is removed from the system 100 and ready for deployment to farms, processing facilities, or the like. For example, after separation in filter container 170, the solid material left in filter container 170 forms a “dry cake.” A person of ordinary skill will recognize that a dry cake material may be formed by residual solids from a filtration process. Further, though the term “dry” is used, a person of ordinary skill will recognize that there may be residual liquid material in the dry cake. A dry cake may be useful in many different ways, for example it may be recycled for different purposes including animal feed, compost material, or as fuel.

Embodiments of the dewatering system included herein provide numerous advantages over the existing approaches. Traditionally, the system for the brewing process discharges a liquid waste from a centrifuge into metal totes and discharges solid waste into plastic totes, requiring manual handling. This practice is not only inefficient and messy, but also unsustainable. Thus, the dewatering system (e.g., system 100), operated as described in the illustrative embodiments herein, allows for a beneficial use of many of the solids and liquids that are processed by the system by automating the entire waste collection and separation process of removing water or other liquid from brewed solids material and eliminating the need for human operation. This change allows for a movement of large waste quantities without operator intervention. For example, system 100 may redirect a waste stream upwards into waste water tank 195A or frac tank 195B, hundreds of feet away from a processing area via pump 170B. Often times material streams like those described herein are waste streams, have no productive use, and are costly to dispose of. System 100 allows for reuse of the solid materials involved (for example, as animal feed) and the recycling of liquid materials involved (for example, by reintroducing the liquid materials ultimately as first material stream 125) and thus creates economically beneficial uses out of materials that otherwise would have no economic use and makes the system more planet-friendly.

The terminology used herein is for the purpose of describing particular embodiments and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

Although a few example embodiments have been described in detail above, those skilled in the art will readily appreciate that many modifications are possible in the example embodiments without materially departing from the scope of the present disclosure, described herein. Accordingly, such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112, paragraph (f) for any limitations of any of the claims herein, except for those in which the claim expressly uses the words ‘means for’ or ‘step for’ together with an associated function.

Having thus described the disclosure of the present application in detail and by reference to embodiments thereof, it will be apparent that modifications and variations are possible without departing from the scope of the disclosure defined in the appended claims.

What is claimed is:

1. A method for dewatering solids comprising:
providing a funnel system comprising multiple funnel injection nozzles and at least one macerator;
introducing a first material stream and a second material stream into the funnel system;
combining the first material stream and the second material stream in the funnel system, resulting in a third material stream;
transporting the third material stream to a filter container from the funnel system and separating solids from liquids contained in the third material stream in the filter container;
removing the third material stream from the filter container by removing separated liquids from the filter container via a fourth material stream by using a hose system powered by a sludge pump configured to transport the fourth material stream to different destinations; and
removing separated solids from the filter container in a form of a dry cake material and recycling the separated solids for different purposes.

2. The method of claim 1, wherein introducing the first material stream into the funnel system includes supplying the first material stream into the funnel system via the multiple funnel injection nozzles.

3. The method of claim 1, wherein the holding tank is configured to supply the first material stream to the funnel system via the multiple funnel injection nozzles configured to move positions relative to the funnel system to facilitate combination of the first material stream and the second material stream.

4. The method of claim 1, wherein the filter container includes an outlet valve at a bottom of the filter container to facilitate removal of the third stream material that passes through a filter to the bottom of the filter container.

5. The method of claim 4, wherein the outlet valve is connected to the hose system to deliver the fourth material stream to the different destinations, the different destinations include at least one of a waste processing facility, a different storage location, and the holding tank.

6. The method of claim 5, wherein the hose system is configured to transport multiple material streams leaving the filter container, each material stream with a different destination.

7. The method of claim 1, wherein the funnel system is configured with different slope angles of a funnel to alter an amount of time that materials are inside the funnel.

8. The method of claim 7, wherein a slope angle of the funnel is altered based on at least altering diameters of a top side or a bottom side of the funnel and a distance between the top side and the bottom side of the funnel.

9. The method of claim 1, wherein the first material stream is an aqueous liquid stream and the second material stream comprises solid material entrained in a liquid.

10. The method of claim 1, wherein the at least one macerator is configured to reduce a particle size of at least some solids entering and exiting the funnel system.

11. A system for dewatering solids comprising:
a funnel system including multiple funnel injection nozzles and at least one macerator;
a holding tank including at least a tank inlet valve and a tank outlet valve, wherein a pump is configured to transport a first material stream from the holding tank to the funnel system;
a chemical pump configured to feed materials to the holding tank;
a filter container powered by a sludge pump; and
a hose system connected to the filter container,
wherein the system is configured to:
introduce the first material stream and a second material stream into the funnel system;
combine the first material stream and the second material stream in the funnel system, resulting in a third material stream;
transport the third material stream to the filter container from the funnel system and separating solids from liquids contained in the third material stream in the filter container;
remove the third material stream from the filter container by removing separated liquids from the filter container via a fourth material stream by using the hose system powered by the sludge pump configured to transport the fourth material stream to different destinations; and
remove separated solids from the filter container in a form of a dry cake material and recycle the separated solids for different purposes.

12. The system of claim 11, wherein introducing the first material stream into the funnel system includes supplying the first material stream into the funnel system via the multiple funnel injection nozzles.

13. The system of claim 11, wherein the holding tank is configured to supply the first material stream to the funnel system via the multiple funnel injection nozzles configured to move positions relative to the funnel system to facilitate combination of the first material stream and the second material stream.

14. The system of claim 11, wherein the filter container includes an outlet valve at a bottom of the filter container to facilitate removal of the third stream material that passes through a filter to the bottom of the filter container.

15. The system of claim 14, wherein the outlet valve is connected to the hose system to deliver the fourth material stream to the different destinations, the different destinations include at least one of a waste processing facility, a different storage location, and the holding tank.

16. The system of claim 15, wherein the hose system is configured to transport multiple material streams leaving the filter container, each material stream with a different destination.

17. The system of claim 11, wherein the funnel system is configured with different slope angles of a funnel to alter an amount of time that materials are inside the funnel.

18. The system of claim 17, wherein a slope angle of the funnel is altered based on at least altering diameters of a top side or a bottom side of the funnel and a distance between the top side and the bottom side of the funnel.

19. The system of claim 11, wherein the first material stream is an aqueous liquid stream and the second material stream comprises solid material entrained in a liquid.

20. The system of claim 11, wherein the at least one macerator is configured to reduce a particle size of at least some solids entering and exiting the funnel system.
